(19) United States
(12) Patent Application Publication
(10) Pub. No.: US 2006/0050834 A1
(43) Pub. Date: Mar. 9, 2006

(54) Coolant recirculation equipment for nuclear reactor

(75) Inventors: Hiroshi Yamazaki, Yokohama-Shi (JP); Kazuo Hisajima, Kamakura-Shi (JP); Fumihiko Ishibashi, Yokohama-Shi (JP); Kenjiro Katayama, Yokohama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/171,317

(22) Filed: Jul. 1, 2005

(30) Foreign Application Priority Data
Jul. 2, 2004 (JP) 2004-197454

(51) Int. Cl. G21C 15/00

(52) U.S. Cl. 376/373

(57) ABSTRACT

A nuclear reactor coolant recirculation equipment includes a plurality of internal pumps which are installed around a bottom portion of a reactor pressure vessel of a boiling-light-water reactor, power-supply sections for supplying current to the internal pumps, an internal pump cooling system, for cooling the internal pumps, including cooling water pipes and heat exchangers connected to the cooling water pipes, and auxiliary cooling water pumps for supplying the cooling water to the heat exchangers, respectively. The positions are set as internal pump installation positions at substantially same interval in a circumferential direction around a central portion of the bottom portion of the reactor pressure vessel, and nine or less and four or more numbers of the internal pumps are installed at the ten internal pump installation positions.

### BACKGROUND OF THE INVENTION

1. Field of the Invention

The present invention relates to a reactor coolant recirculation equipment for a boiling water type light water reactor (boiling-light-water reactor) particularly capable of reducing number of coolant recirculation pump accommodated in a nuclear reactor (called internal pump hereinlater) improving safety measure against an accident of power-supply section and simplifying a structure of a cooling water system of the internal pump.

2. Related Art

In general, a reactor coolant recirculation equipment or system of the boiling water reactor is provided for a reactor pressure vessel, and by forcibly recirculating the coolant to a core in a core shroud, heat or heated steam in the core is removed. In addition, nuclear reactivity of the core is adjusted by changing a flow rate of the reactor coolant, thus controlling a plant power output.

There are known, as reactor coolant recirculation equipment, a so-called external recirculation system in which a coolant circulation loop is arranged outside the reactor pressure vessel or a so-called internal pump system in which internal pumps are arranged in the reactor pressure vessel.

In the above connection, FIG. 8 is an illustration of an elevational section showing a structure in the reactor pressure vessel to which the internal pump system is adopted, and FIG. 9 is a plan view of a lower portion of the reactor pressure vessel showing the arrangement of the internal pumps.

As shown in FIG. 8, a core 2 is disposed in the reactor pressure vessel 1 and is surrounded by a core shroud 8. The internal pump 3 is accommodated in a motor casing welded to a nozzle 4 at a bottom portion of the reactor pressure vessel 1. Further, in general, as shown in FIG. 9, ten internal pumps 3 are arranged on the bottom portion of the reactor pressure vessel 1 circumferentially at an equal interval so as to serve to forcibly circulate the coolant in the core 2.

FIG. 10 shows a power-supply system and a motor cooling system for the internal pumps 3, and for the sake of convenience, the systems only for two internal pumps 3 are shown.

As shown in FIG. 10, each of the internal pumps 3 is variably controlled by receiving current at a variable frequency supplied from a stationary type power-supply device 9 to a motor, not shown, of the internal pump 3.

In order to keep constant a temperature of the motor of the internal pump 3, a motor cooling unit 26 is provided for each internal pump 3, the motor cooling unit 26 including a motor cooling water pipe 10 and an internal pump heat exchanger 11, and the motor cooling water is circulated by utilizing a driving power of the internal pump 3. The motor cooling unit 26 is also provided with an auxiliary cooling system 12 for cooling auxiliary equipments or members arranged in a nuclear power plant so that a natural circulation of the cooling water is caused by such auxiliary cooling system 12 even if the internal pump 3 is stopped in its operation to thereby keep the temperature of the motor section below a predetermined temperature.

Such technology is, for example, disclosed in Japanese Patent Laid-open (KOKAI) Publication No. HEI 10-10273 and Japanese Patent Laid-open (KOKAI) Publication No. 2003-156585.

With reference to FIGS. 9 and 10, the ten internal pumps 3 are supplied with current alternately (i.e., A.C.) from one-series power-supply section 18 and other-series power-supply section 19, which are independent from each other and are commonly utilized to A-series power-supply section 18 and B-series power-supply section 19 for auxiliary cooling pumps 20 for supplying water to the heat exchangers 11 of the respective internal pumps 3. According to such arrangement, even if one power-supply section is stopped in operation and, hence, five internal pumps 3 and auxiliary cooling pumps 20 in the same section of these five internal pumps 3 are stopped in operation, the cooling water supply can be continuously achieved by remaining alternately arranged five internal pumps 3 and auxiliary cooling pumps 20, thus preventing the core coolant flow rate from being rapidly reduced.

FIG. 11 shows a layout of the internal pumps 3 in a reactor concrete containment vessel 5, and FIG. 12 shows a sectional view of an internal pump maintenance area in a lower drywell 6 disposed below the reactor pressure vessel 1.

As shown in FIGS. 11 and 12, the lower drywell 6 is disposed below the reactor pressure vessel 1, and this lower drywell 6 and an external portion of the reactor concrete containment vessel 5 are communicated with each other through an access tunnel 21. In addition, in the location area of this lower drywell 6, there is provided a space 13 for conveying the internal pump 3 from the lower drywell 6 through an access tunnel 21 to an external portion of the reactor concrete containment vessel 5 or for withdrawing the internal pump for installing, assembling and/or disassembling or inspecting workings of the internal pumps 3.

In the case where the maintenance or inspection working is done around the internal pumps 3, a worker or operator approaches or accesses a walking corridor 14 by using a ladder 16 or stairs 17 from a platform 23 formed in the lower drywell 6. That is, it is necessary for this purpose to form an opening or openings 15 to the corridor 14 and prepare the ladder 16 or stairs 17.

In addition, around the corridor 14, it is necessary to provide a withdrawal space 13 for the installation, disassembling and/or inspection of the internal pumps 3.

In the case of the maintenance and inspection of the internal pumps 3, it is necessary, as mentioned above, to perform the withdrawing, installing or like working of the internal pump 3 in the lower drywell 6. However, the openings 15 are formed on the access passage to the space in which the necessary workings to the internal pumps 3 are performed and the internal pump maintenance space 13 is also formed near the openings 15. Accordingly, a moving working of a worker inside the lower drywell 6 may interfere with the internal pump maintenance and/or inspection working.

Such inconvenience may be improved if installation number of the internal pumps 3 could be reduced, and the maintenance or inspection workability inside the lower drywell 6 can be hence improved. However, as mentioned before, in a usual conventional design, since the ten internal pumps 3 are arranged, the reduction of the installation number of the internal pumps resulted in considerable and complicated change of layout or design of the reactor pressure vessel or equipments or devices disposed therein.

In addition, in order to improve the internal pump maintenance and/or inspection working in the lower drywell 6, it may be considered to commonly utilize, for a plurality of internal pumps 3, a heat exchanger 11 connected to the respective internal pumps 3 through a motor cooling system 26. However, in the case that cooling water pipes or like of a plurality of internal pumps 3 are combined, it becomes difficult to maintain a stable cooling performance or ability properly responding to the operating condition of the respective internal pumps 3. For example, in a case where the cooling water pipes of the plural internal pumps 3 are combined under a condition that one side internal pump is tripped or the internal pumps are operated at different revolution numbers, there may cause a case that, because of the difference of powers of the respective pumps, the cooling water does not circulate on the one side internal pump and it is hence difficult to maintain the temperature around the motor section below a predetermined allowable temperature.

Furthermore, in a case where two adjacent internal pumps are cooled by one heat exchanger in the arrangement mentioned above, there is a fear that if the power-supply system in one section becomes faulty or disordered, seven or more internal pumps 3 may become inoperative. This will result in that the coolant flow rate in the core is largely reduced more than that caused in a conventional nuclear power plant.

### SUMMARY OF THE INVENTION

The present invention was conceived in consideration of the circumstances in the prior art mentioned above and an object of the present invention is to provide a reactor coolant recirculation equipment, in which a cooling water system of internal pumps can be simplified to thereby improve workability of workers or operators in a lower drywell in a reactor pressure vessel of a nuclear power plant, and, moreover, it makes possible to reduce the number of the internal pumps to be arranged without reducing the core coolant flow rate even in a case of fault of a power-supply section in comparison with a conventional arrangement of a nuclear power plant.

This and other objects can be achieved according to the present invention by providing, in one aspect, a nuclear reactor coolant recirculation equipment including: a plurality of internal pumps which are installed around a bottom portion of a reactor pressure vessel of a boiling-light-water reactor and are provided with motors, respectively; power-supply sections for supplying current to the internal pumps so as to drive same; an internal pump cooling system, for cooling the internal pumps, including cooling water pipes and heat exchangers connected to the cooling water pipes; and an auxiliary cooling water pump for supplying the cooling water to the heat exchangers, respectively, wherein ten positions are set as internal pump installation positions at substantially same interval in a circumferential direction around a central portion of the bottom portion of the reactor pressure vessel, and nine or less and four or more numbers of the internal pumps are installed at the ten internal pump installation positions.

In preferred embodiments of the above aspect, the following additional characteristic features may be desired.

Ten nozzles, each having a shape suitable for the installation of the internal pump, are formed to the ten internal pump installation positions, respectively, and nozzles at which the internal pumps are not installed are closed, for example, by closing plates by means of welding.

A passage for maintenance and inspection of the internal pump is formed in a protruded shape at a portion below the internal pump installation position other than the installation positions at which the internal pumps are installed, and a ladder or stairs as an access member to a walking corridor utilized for a worker to carry out maintenance and inspection of the internal pump may be arranged near the protruded passage.

In another aspect of the present invention, there is also provided a nuclear reactor coolant recirculation equipment comprising:
a plurality of internal pumps which are installed around a bottom portion of a reactor pressure vessel of a boiling-light-water reactor and are provided with motors, respectively;
power-supply sections for supplying current to the internal pumps so as to drive same;
an internal pump cooling system, for cooling the internal pumps, including cooling water pipes and heat exchangers connected to the cooling water pipes; and
auxiliary cooling water pumps for supplying the cooling water to the heat exchangers, respectively,
wherein a plurality of internal pumps are connected to one heat exchanger through the cooling water pipes, and the heat exchanger has an inner portion separated into a plurality of sections correspondingly to the plurality of internal pumps connected thereto so as to provide cooling water supply passages in the heat exchanger for each of the internal pumps.

In preferred embodiments of this aspect, it may be desired that two internal pumps are connected to one heat exchanger through the cooling water pipes, respectively, and the inner portion of the heat exchanger is separated into two sections by means of partition plate.

A power-supply section for supplying power to the internal pumps and a power-supply section for the auxiliary cooling water pump for supplying the cooling water to the heat exchangers for the respective internal pumps are common.

According to the present invention of the characters mentioned above, the ten positions are set as internal pump installation positions at substantially same interval in a circumferential direction around a central portion of the bottom portion of the reactor pressure vessel, and nine or less and four or more numbers of the internal pumps are installed at the ten internal pump installation positions. Thus, the reduction of the numbers of the internal pumps to be installed can be achieved, thus being advantageous.

Furthermore, a plurality of internal pumps are connected to one heat exchanger, which has the inner portion divided into a plurality of sections corresponding to the numbers of the internal pumps connected thereto as the cooling water passing sections. According to such structure, the cooling water supply system for the internal pumps can be simplified and workability and accessibility of the worker in the lower drywell can be improved. Still furthermore, even at a time of power-supply fault, the core coolant flow amount can be still maintained properly in comparison with the conventional structure of the nuclear reactor plant.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is an illustrated sectional view of a reactor pressure vessel provided with a reduced number of internal pumps according to a first embodiment of the present invention.

FIG. 2 is a diagram representing a relative relationship among a revolution number of the internal pump, a total head and a hydraulic performance or characteristics of the internal pumps in the first embodiment;

FIG. 3 is an illustration of a reactor power plant showing a shift of location of the internal pumps according to a second embodiment of the present invention;

FIG. 4 is an illustrated plan view of an arrangement of the internal pumps and a walking corridor for maintenance and/or inspection of the internal pumps according to a third embodiment of the present invention;

FIG. 5 is an illustrated plan view showing an arrangement of the internal pumps and a heat exchanger for the internal pump according to a fourth embodiment of the present invention;

FIG. 6 includes schematic views of FIGS. 6A and 6B of the heat exchanger for the internal pump according to the fourth embodiment of the present invention;

FIG. 7 is an illustrated plan view of an arrangement of internal pumps, a heat exchanger and a power-supply section according to a fifth embodiment of the present invention;

FIG. 8 is an illustration of a boiling water reactor power plant provided with internal pumps according to a conventional arrangement;

FIG. 9 is a plan view showing an arrangement of conventional internal pumps;

FIG. 10 is a system diagram of a power-supply section and a motor cooling section of internal pumps according to the conventional technology;

FIG. 11 is an illustrated sectional view of a reactor pressure vessel and a containment vessel provided with the reactor pressure vessel of the conventional structure; and

FIG. 12 is an illustrated plan view of an arrangement of the internal pumps and a walking corridor for maintenance and/or inspection of the internal pumps according to the conventional technology.

### DESCRIPTION OF THE PREFERRED EMBODIMENTS

Preferred embodiments of the present invention will be described hereunder with reference to the accompanying drawings.

### FIRST EMBODIMENT

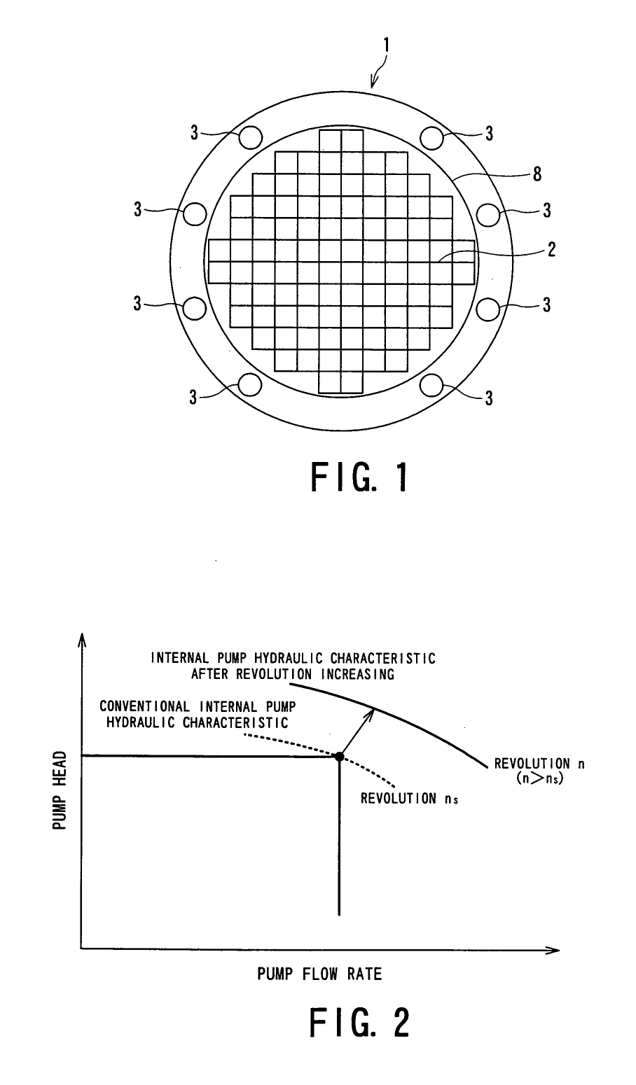

A first embodiment of a nuclear reactor coolant recirculation equipment or system of the present invention will be first described with reference to FIGS. 1 and 2.

With reference to FIG. 1, a plurality of internal pumps 3 are arranged at a peripheral portion of a bottom portion of a reactor pressure vessel 1 of a boiling water type light water reactor, which may be called herein as boiling-light-water reactor. In this reactor coolant recirculation equipment, the internal pumps 3 are driven by electric motors each provided for each internal pump 3, and the internal pumps 3 are also provided with power-supply units or sections for driving the motors, cooling water pipes for cooling the internal pumps 3, heat exchangers for the internal pumps, and auxiliary cooling water pumps for supplying cooling water to the heat exchangers, though not shown in FIG. 1.

In such reactor coolant recirculation equipment, ten installation positions of the internal pumps 3 are set at substantially equal interval in the circumferential direction around the center of the bottom portion of the reactor pressure vessel, and a plurality of, such as four or more and nine or less, internal pumps 3 are arranged at these installation positions. For example, eight internal pumps 3 are arranged as shown in FIG. 1, and any unit or element is not disposed at the other installation positions, two in the illustrated embodiment, at which the internal pumps 3 are not arranged.

That is, in this embodiment, two internal pumps 3 are eliminated in comparison with the arrangement of the conventional reactor coolant recirculation equipment.

In such arrangement as shown in FIG. 1, a capacity of a stationary-type power-supply device for supplying driving current to the internal pump 3 is made large and is set high in its frequency. As mentioned, according to the reactor coolant recirculation equipment of this embodiment, it becomes possible to supply core coolant flow rate in accordance with the power of the reactor using the same internal pumps, reduced in location numbers, by increasing the flow rate and head of the respective internal pumps in comparison with the conventional arrangement in which ten internal pumps are arranged.

Function of each of the internal pumps 3 will be explained with reference to FIG. 2.

For example, the increased revolution “n” of the internal pump 3 of this embodiment is set to be higher than the revolution “ns” at the operation point of the conventional internal pump (n>ns), and that is, hydraulic performance of each internal pump after its revolution being increased is shifted to a higher level.

According to the reactor coolant recirculation equipment of this first embodiment, the number of the internal pumps 3 to be arranged can be reduced without changing the arrangement and outer shapes of other equipments or elements in the lower drywell of the reactor pressure vessel 1 with the ten installation positions of the internal pumps being maintained as they are.

### SECOND EMBODIMENT

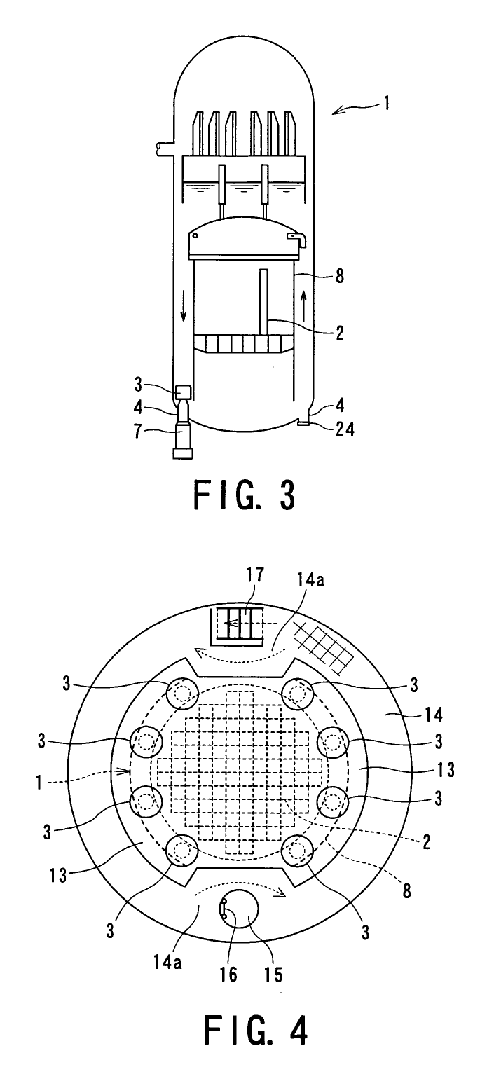

FIG. 3 represents the illustrated arrangement of the second embodiment of the present invention, which shows a closing state of a nozzle or nozzles 4. In general, nozzles are formed to the bottom portion of the. reactor pressure vessel 1 at portions corresponding to the installation of the internal pumps, and the nozzle 4 has a shape capable of installing the internal pump 3.

In the arrangement of this embodiment, the ten nozzles 4 are formed to the installation position of the internal pumps 3, and the nozzles 4 corresponding to no location of the internal pumps 3 are closed by closing plates 24 by means of, for example, welding. Further, in a case that requirement of increasing of the internal pumps 3 to be installed is caused in future because of power-up demand, for example, the internal pump 3 can be easily additionally installed and removing the closing plate 24.

Further, flanges or like members, which are detachably attached by means of bolts, may be utilized in place of the closing plate 24. Reference numeral 7 in FIG. 3 shows a motor casing.

### THIRD EMBODIMENT

FIG. 4 shows a sectional view of the lower drywell, representing the third embodiment of the present invention, in which like reference numerals are added to portions or members corresponding to those of the first embodiment and repeated description is omitted herein.

In this third embodiment, eight internal pumps 3 are installed at eight positions in the ten internal pump installation positions set around the circumferential direction of the bottom portion of the reactor pressure vessel 1, and two internal pumps 3, which are to be installed to opposing two portions, are removed. A passage 14a protruded for maintenance and/or inspection of the internal pump 3 is formed to a walking corridor 14 below the reactor pressure vessel 1 and below either one of the internal pump installation positions at which the internal pumps 3 are not installed. A ladder 16 or stairs 17 are arranged, as access means to the walking corridor 14, near the passage 14a.

In the structure of such reactor coolant recirculation equipment of this third embodiment shown in FIG. 4, an internal pump withdrawal space 13 is formed below the reactor pressure vessel 1 for performing an installation working, inspection working or like working to each of the respective internal pumps 3. However, according to this embodiment, eight, not ten, internal pumps 3 are installed, and two portions, corresponding two portions at which the internal pumps 3 are not installed, which are utilized as internal pump withdrawal spaces 13 in the conventional arrangement, can be utilized as such passage 14a, and the ladders 16 or stairs 17 can be also arranged as access means at portions not interfering the passage 14a, thus improving working performance or workability of workers or operators.

### FOURTH EMBODIMENT

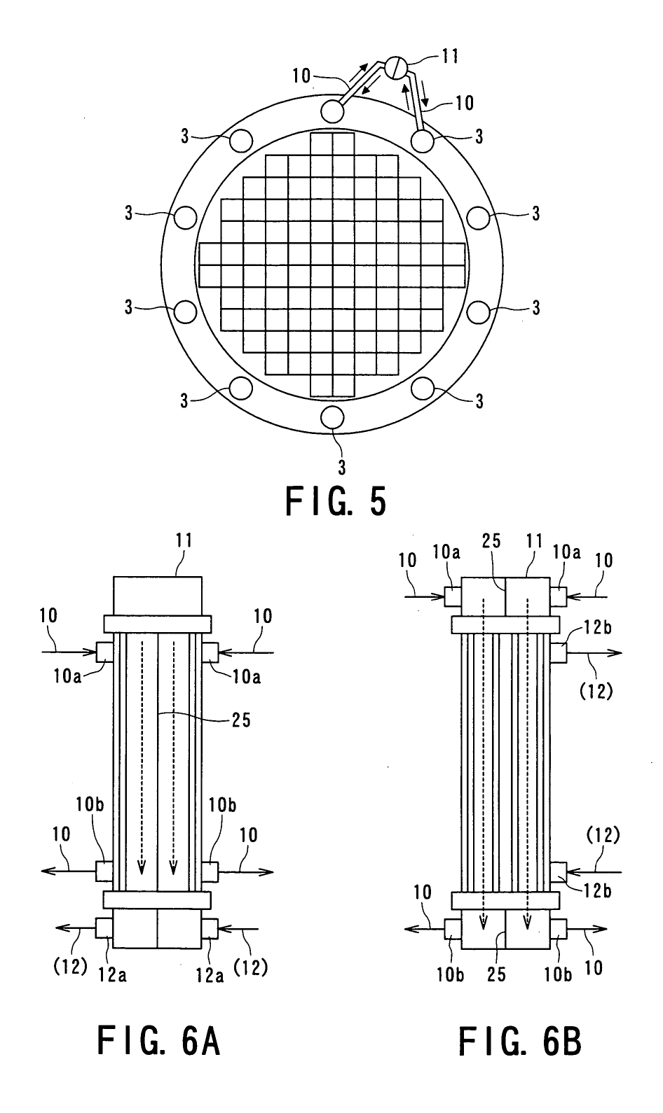

This fourth embodiment is represented by FIG. 5 and FIG. 6 (FIGS. 6A and 6B), in which like reference numerals are added to portions or members corresponding to those in the former embodiment and repeated description will be omitted herein.

With reference to FIG. 5, in this fourth embodiment, a plurality of, two, for example, internal pumps 3 are connected to one heat exchanger 11 through cooling water pipes or lines 10, and cooling water supply passages, which are sectioned for the respective internal pumps 3, are formed in the heat exchanger 11. That is, two passages are formed in this embodiment.

In the heat exchangers 11 shown in FIGS. 6A and 6B, vertical-type heat exchangers 11 are adopted in the view point of operational efficiency of the heat exchanger due to natural convection of the cooling water. The inner space of this heat exchanger 11 is sectioned or divided by a partition plate 25 at its central position, for example, into two sections corresponding to the respective internal pumps 3. That is, the location of such partition plate 25 prevents the cooling waters for the different internal pumps 3 from being combined in the heat exchanger 11.

Further, in order to promote the flow of the cooling water, due to the natural convection, in the vertical-type heat exchanger 11, the cooling water pipe 10 has an inlet side 10a at an upper portion thereof and, on the other hand, an outlet side 10b at a lower portion thereof as shown in FIG. 6. That is, in both the examples shown in FIGS. 6A and 6B, the cooling waters passing through the cooling water pipes10 flow downward in directions shown by dotted arrows.

The auxiliary cooling equipment 12 for guiding the cooling water of the internal pump 3 may be connected to portions 12a of the cooling water pipe 10 or shell or body sides 12b of the vertical-type heat exchangers 11 as shown in FIGS. 6A and 6B.

In the arrangement of FIG. 6A, the cooling water from the auxiliary cooling equipment 12 flows in the vertical-type heat exchanger 11 through the lower portion thereof, then turns downward at the upper portion thereof and then flows out from the lower portion of the heat exchanger 11 again to the auxiliary cooling water equipment 12. On the other hand, in the arrangement of FIG. 6B, in order to promote the flow of the cooling water due to the natural convection, the cooling water from the auxiliary cooling water equipment 12 flows in the heat exchanger 11 through the lower shell portion and flows out through the upper portion thereof.

According to the structure of the heat exchanger 11 shown in FIG. 6, since the inside of one heat exchanger 11 is separated into a plurality of sections for the flows of the cooling water for the corresponding internal pumps 3, the cooling stable capacity and/or performance for the internal pumps 3 can be achieved and maintained, respectively individually, in accordance with the operational conditions of the respective internal pumps 3. Moreover, according to this embodiment, since the location number of the heat exchanger 11 can be reduced, the inner space around the internal pumps 3 in the lower drywell 3 can be increased, which will result in easy and improved maintenance and/or inspection working therein. Further, it is to be noted that more than two internal pumps 3 may be connected to one heat exchanger 11, and the last one internal pump 3 may be connected to one heat exchanger 11.

### FIFTH EMBODIMENT

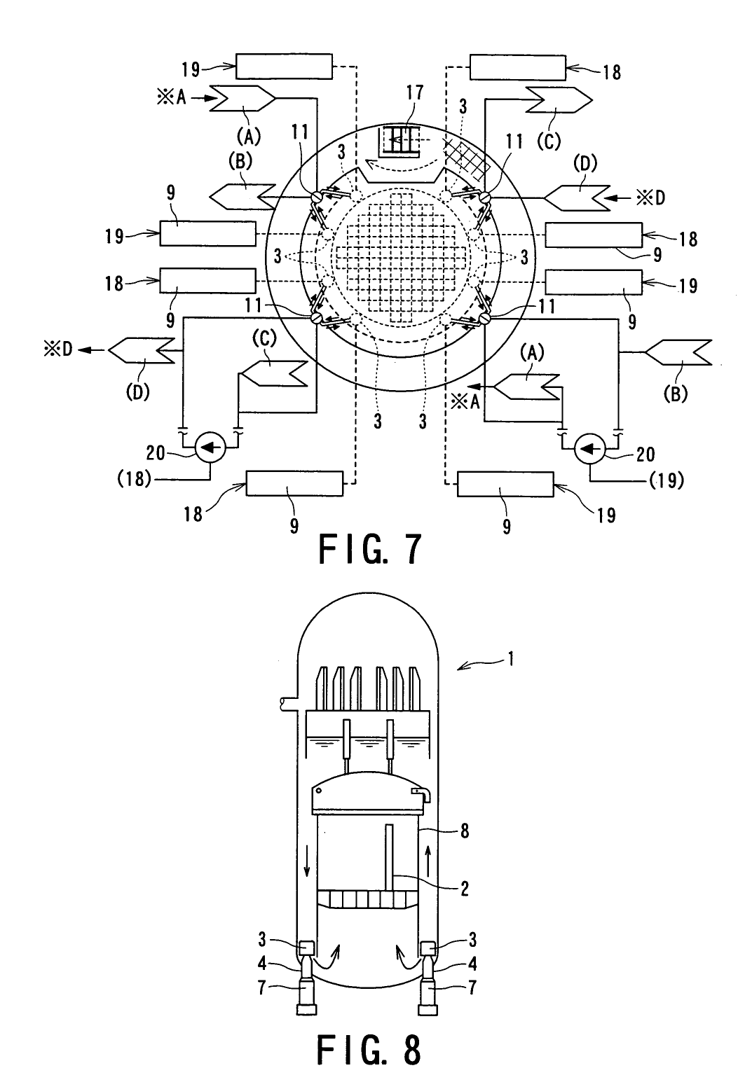

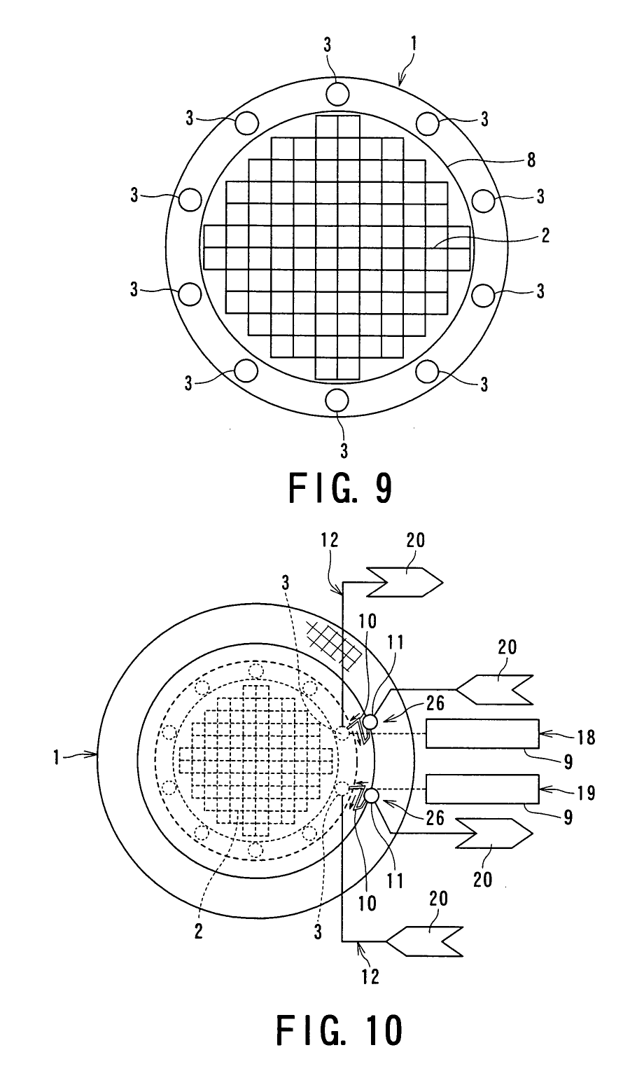

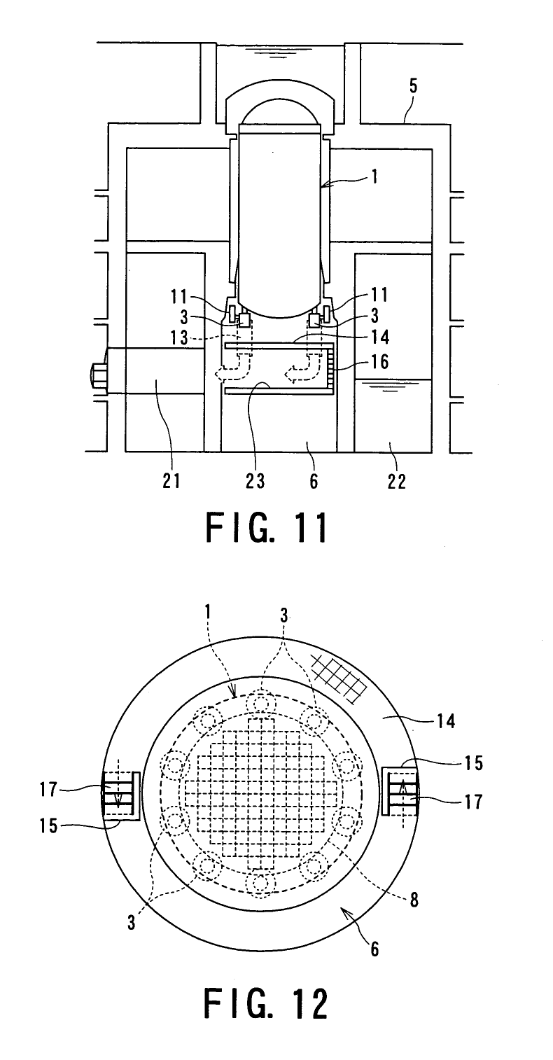

FIG. 7 represents the fifth embodiment of the present invention showing power-supply sections for the heat exchangers 11 for the respective internal pumps 3.

In this fifth embodiment, eight internal pumps 3 are arranged, in which a plurality of, for example, two, power-supply sections (A-section 18, B-section 19) independent from each other are provided and a plurality of, the same as those of the power-supply sections, two in this embodiment, power-supply sections (A-section 18, B-section 19) of the auxiliary cooling water pumps 20, independent from each other are also provided. These power-supply sections (A-sections 18 and B-sections 19) for two internal pumps 3 connected to one heat exchanger 11 and two auxiliary cooling water pumps 20 are utilized commonly. That is, the same A-section 18 and B-section are commonly utilized for the internal pumps 3 and the corresponding auxiliary cooling water pumps 20.

In the case where adjacent two internal pumps 3 are driven to perform the cooling through one heat exchanger 11, since the power-supply sections for the auxiliary cooling water pumps 20 for supplying the cooling water to the heat exchanger 11are utilized commonly to those for the corresponding internal pumps 3, even if one of the A- and B-sections becomes defective, half numbers of the internal pumps 3 can be operated.

As mentioned above, according to the present invention, in the arrangement of the even number of internal pumps 3, even if one power-supply section becomes defective, the half number of the internal pumps 3 still become operative, and accordingly, the reduction of the core coolant flow rate due to the faulty of the power-supply can be attenuated to approximately same extent as that in the arrangement in the conventional nuclear power plant.

Moreover, in the arrangement of the eight internal pumps 3, as mentioned above, the power-supply section for the internal pumps 3 and the power-supply section for the auxiliary cooling water pump 20 for supplying the cooling water to the heat exchanger 11 are made common, so that the cooling water flow distribution in the nuclear reactor in the horizontal direction can be well maintained.

In the arrangement of FIG. 7, the power-supply sections C and D correspond to the sections A and B, respectively, and duplicated description thereof will be omitted herein. That is, the cooling water flow from the A-section (right-lower section in FIG. 7) is guided to the other A-section (left-upper section in FIG. 7), and also, the cooling water flow from the D-section (left-lower section in FIG. 7) is guided to the other D-section (right-upper section in FIG. 7).

According to the embodiments of the present invention of the structures mentioned above, the space arrangement around the internal pumps 3 in the lower drywell 6 below the reactor pressure vessel 1 can be improved, and in addition, in the improved arrangement of the power-supply sections, even if one power-supply section becomes defective, the half number of the internal pumps 3 still become operative, and accordingly, the reduction of the core coolant flow rate due to the faulty of the power-supply can be attenuated. The maintenance and/or inspection workings of the internal pumps can be also improved.

It is further to be noted that the present invention is not limited to the described embodiments and many other changes and modifications may be made without departing from the scopes of the appended claims.

What is claimed is:

1. A nuclear reactor coolant recirculation equipment including: a plurality of internal pumps which are installed around a bottom portion of a reactor pressure vessel of a boiling-light-water reactor and are provided with motors, respectively; power-supply sections for supplying current to the internal pumps so as to drive same; an internal pump cooling system, for cooling the internal pumps, including cooling water pipes and heat exchangers connected to the cooling water pipes; and an auxiliary cooling water pump for supplying the cooling water to the heat exchangers, respectively, wherein ten positions are set as internal pump installation positions at substantially same interval in a circumferential direction around a central portion of the bottom portion of the reactor pressure vessel, and nine or less and four or more numbers of the internal pumps are installed at the ten internal pump installation positions.

2. The reactor coolant recirculation equipment according to claim 1, wherein ten nozzles, each having a shape suitable for the installation of the internal pump, are formed to the ten internal pump installation positions, respectively, and nozzles at which the internal pumps are not installed are closed.

3. The reactor coolant recirculation equipment, according to claim 2, wherein the nozzles at which the internal pumps are not installed are closed by closing plates by means of welding.

4. The reactor coolant recirculation equipment according to claim 1, wherein a passage for maintenance and inspection of the internal pump is formed in a protruded shape at a portion below the internal pump installation position other than the installation positions at which the internal pumps are installed and an access member to a walking corridor utilized for a worker to carry out maintenance and inspection of the internal pump is arranged near the protruded passage.

5. The reactor coolant recirculation equipment according to claim 4, wherein the access means is either one of ladder and stairs.

6. A nuclear reactor coolant recirculation equipment comprising:
a plurality of internal pumps which are installed around a bottom portion of a reactor pressure vessel of a boiling-light-water reactor and are provided with motors, respectively;
power-supply sections for supplying current to the internal pumps so as to drive same;
an internal pump cooling system, for cooling the internal pumps, including cooling water pipes and heat exchangers connected to the cooling water pipes; and
auxiliary cooling water pumps for supplying the cooling water to the heat exchangers, respectively,
wherein a plurality of internal pumps are connected to one heat exchanger through the cooling water pipes, and the heat exchanger has an inner portion separated into a plurality of sections correspondingly to the plurality of internal pumps connected thereto so as to provide cooling water supply passages in the heat exchanger for each of the internal pumps.

7. The reactor coolant recirculation equipment according to claim 6, wherein two internal pumps are connected to one heat exchanger through the cooling water pipes, respectively, and the inner portion of the heat exchanger is separated into two sections by means of partition plate.

8. The reactor coolant recirculation equipment according to claim 6, wherein a power-supply section for supplying power to the internal pumps and a power-supply section for the auxiliary cooling water pump for supplying the cooling water to the heat exchangers for the respective internal pumps are common.
